(19) United States
(12) Patent Application Publication
(10) Pub. No.: US 2008/0036877 A1
(43) Pub. Date: Feb. 14, 2008

(54) NETWORK CAMERA AND CONTROL METHOD THEREOF

(75) Inventor: Yuji ARIMA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/835,565

(22) Filed: Aug. 8, 2007

(30) Foreign Application Priority Data
Aug. 9, 2006 (JP) 2006-216890

(51) Int. Cl. H04N 5/76

(52) U.S. Cl. 348/231.8; 348/E05.024

(57) ABSTRACT

The network camera of the present invention is connected to a terminal apparatus, and includes a camera and a memory. The camera photographs an image and is movable within a predetermined photographing range. The memory stores predetermined positional information indicating a position of the predetermined object. It is prohibited to display the image of the predetermined object on the terminal apparatus. The network camera has a controller that controls the camera to move within the photographable range to acquire a series of images from the camera at predetermined time periods. The controller, when acquiring the image including the predetermined object based on the predetermined positional information, performs a masking process operation with respect to a predetermined image area that includes both the image of the predetermined object acquired at a present time period and the image of the predetermined object acquired at one time period previous to the present time period.

### BACKGROUND

1. Field of the Invention

The present invention is related to a network camera and a control method thereof, and in particular but not exclusively to a camera and method capable of masking an area which is not to be photographed by a camera when the camera is panned, tilted, or zoomed.

2. Description of the Related Art

Very recently, image distributing apparatuses have been widely popularized, from which when the image distributing apparatuses are accessed via networks from a large number of terminal apparatuses, images are distributed. Among these image distributing apparatuses, network cameras equipped with camera apparatuses have been widely marketed. These network cameras are operable as follows: for instance, while a Web server is communicated with Web browsers of terminal apparatuses such as personal computers via IP networks, the network cameras transmit photographed images to the respective terminal apparatuses.

On the other hand, one common application for network cameras is that of monitoring cameras. Monitoring cameras are utilized in order that photographed images are distributed to reception terminal apparatuses, and then, the reception terminal apparatuses monitor these images. Generally speaking, in order to acquire information of interest by monitoring persons, for example information about a suspicious character, network cameras transmit images which have been directly photographed to reception terminal apparatuses, while these network cameras do not perform specific image processing operations. In the reception terminal apparatuses, the received images are displayed, and motoring persons or programs judge whether or not suspicious characters appear by visually checking these images.

However, there are some possibilities that if images received by the reception terminal apparatuses are directly displayed, then these images may cause privacy problems and/or security problems. For instance, these images may correspond to personal private information and/or other secret information. Under such a circumstance, one monitoring camera apparatus capable of protecting the above-explained secret aspect has been proposed (refer to patent publication 1). The monitoring camera apparatus described in the patent publication 1 is arranged by a monitoring camera and a control apparatus for controlling the monitoring camera which is rotatable by 360 degrees along a panning direction, and by 90 degrees, or larger angles along a tilting direction. While masking data for masking privacy zones displayed in images have been stored in the monitoring camera, a portion of acquired images is masked in accordance with the stored masking data. Since a portion of the images is merely concealed, privacy aspects can be protected without deteriorating monitoring functions. Since the masking data have been held in the monitoring camera, quick processing operations can be carried out.

It should be understood that another monitoring camera has been proposed in a patent publication 2 as a monitoring camera having a similar function. This monitoring camera deletes an area which is not wanted even by a monitoring staff from an image photographed by the monitoring camera, and then, transmits the resulting image to a monitoring center. Although the patent publication 2 discloses such a case that a mask area uses an unchanged mask, the mask area may be adapted to another case that an imaging area is varied along upper, lower, right, and left directions by zooming, panning, and tilting the monitoring camera.

Patent Publication 1: JP-A-2001-69494

Patent Publication 2: JP-A-2003-61076

As previously described, the conventional network cameras directly transmit the photographed images without any rearrangement. As a result, there is such a risk that the secret aspects may be revealed. To the contrary, the monitoring cameras described in the patent publications 1 and 2 partially mask the privacy zones of the images based upon the masking data, and thus, can protect the privacy without deteriorating the monitoring functions.

However, in the monitoring apparatus of the patent publication 1, in such a case that panning speeds, or tilting speeds of the camera becomes higher than, or equal to a predetermined speed, calculations of mask zones cannot catch up with these high-speed rotations of the camera. As a result, images are displayed at earlier times than that of these calculations, so that masking positions are shifted from such an image range whose privacy should be actually protected. Under such a circumstance, the monitoring apparatus makes limitations in moving speeds of the camera. On the other hand, the monitoring camera disclosed in the patent publication 2 does not pay any attention to the above-described problem, but also does not disclose any moving speed limitation.

When network cameras are utilized, it is desirable that no longer any limitation is made in moving speeds of panning and tilting operations, and also, no limitation is similarly made even in such a case that the network cameras are panned and/or tilted during zooming operations thereof. Then, there is another problem. That is, in order to reduce the positional shift between this mask area and the range whose privacy should be actually protected, if a correcting means is newly conducted, then this new correcting means necessarily requires a large amount of calculations, so that delays are newly produced. If such a new correcting means constitutes the opposite of the original purpose, then a further problem may occur.

### SUMMARY

As a consequence, the present invention seeks to provide a network camera and a control method thereof, capable of firmly masking a privacy zone even when the network camera is being panned, tilted, and furthermore, zoomed, and capable of readily calculating a mask area, whilst seeking to avoid an upper limit to moving speeds of panning and tilting operations.

To address the above-described problems, the network camera, according to the present invention, is configured to be connected to a terminal apparatus, and includes a camera and a memory. The camera photographs an image and is movable within a predetermined photographing range, and the memory stores predetermined positional information indicating a position of the predetermined object. It is prohibited to display the image of the predetermined object on the terminal apparatus. The network camera also has a controller that controls the camera to move within the photographable range to acquire a series of images from the camera at predetermined time periods. The controller, when acquiring the image including the predetermined object based on the predetermined positional information, performs a masking process operation with respect to a predetermined image area that includes both the image of the predetermined object acquired at a present time period and the image of the predetermined object acquired at one time period previous to the present time period.

### BRIEF DESCRIPTION OP THE DRAWINGS

FIG. 1 is a diagram for showing a network structure of a network camera system;

FIG. 2 is a diagram for indicating an arrangement of a network camera;

FIG. 3 is an explanatory diagram for explanating a masking process operation of the network camera;

FIG. 4(a) is an explanatory diagram in the case that a privacy zone is exposed in a masking operation before an image is acquired;

FIG. 4(b) is an explanatory diagram in the case that a privacy zone is exposed in a masking operation after an image is acquired;

FIG. 4(c) is an explanatory diagram in the case that a privacy zone is not exposed in a masking operation before and after an image is acquired;

FIG. 5 is a sequential diagram for representing an image communicating operation performed in the network camera system;

FIG. 6 is a flow chart for describing a masking process operation of the network camera ; and

FIG. 7 is a flow chart for explaining a masking operation of a network camera.

### DETAILED DESCRIPTION

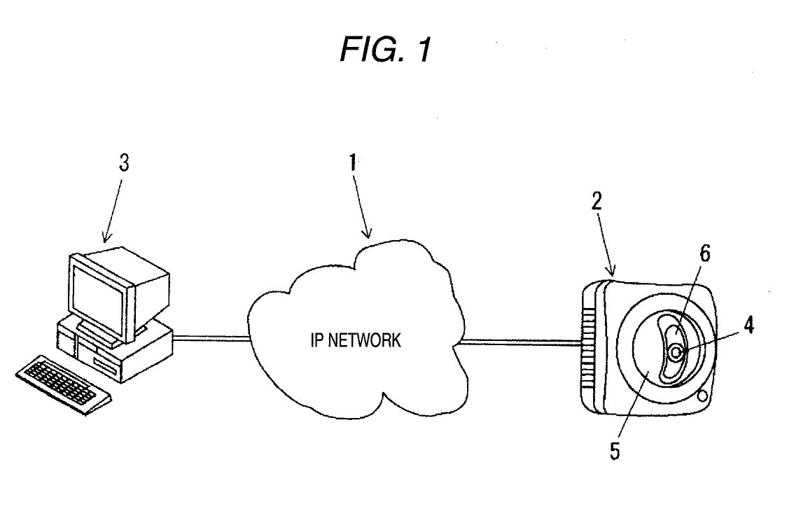

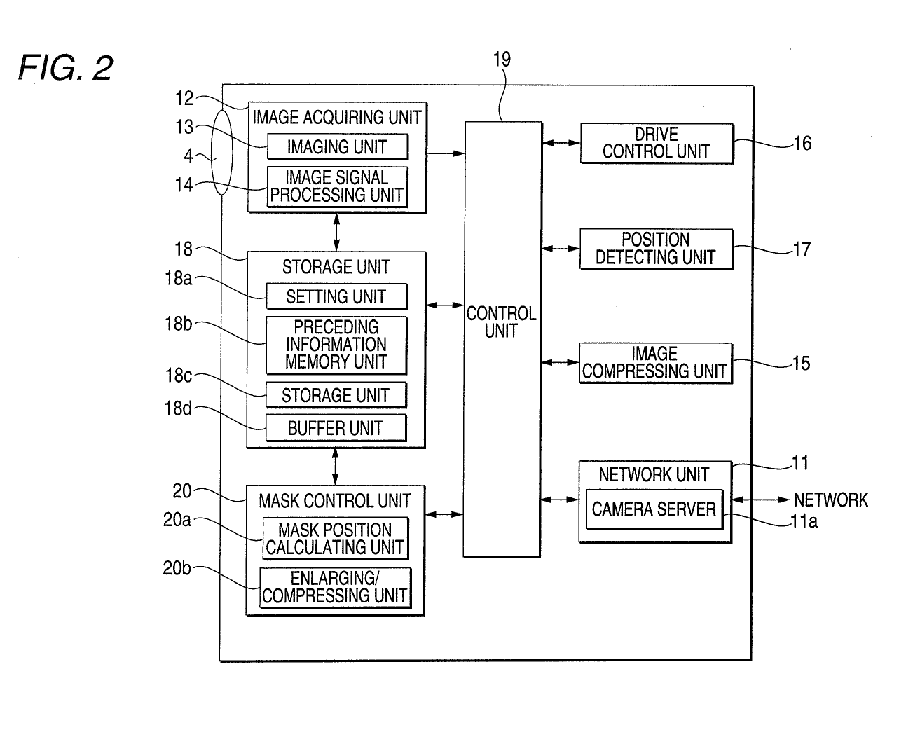

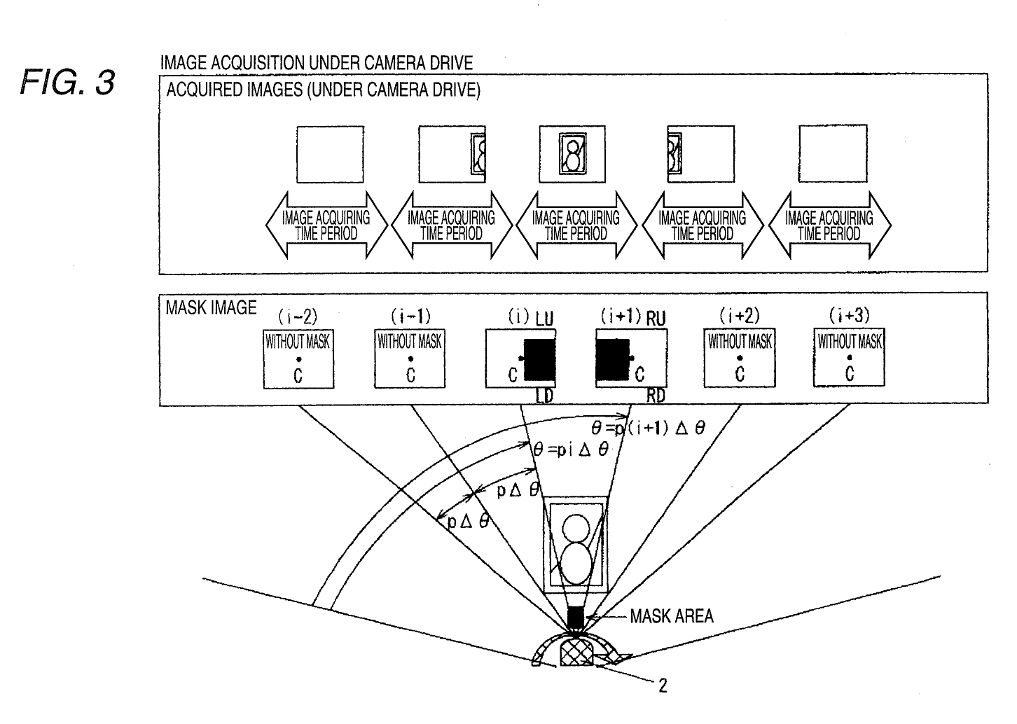

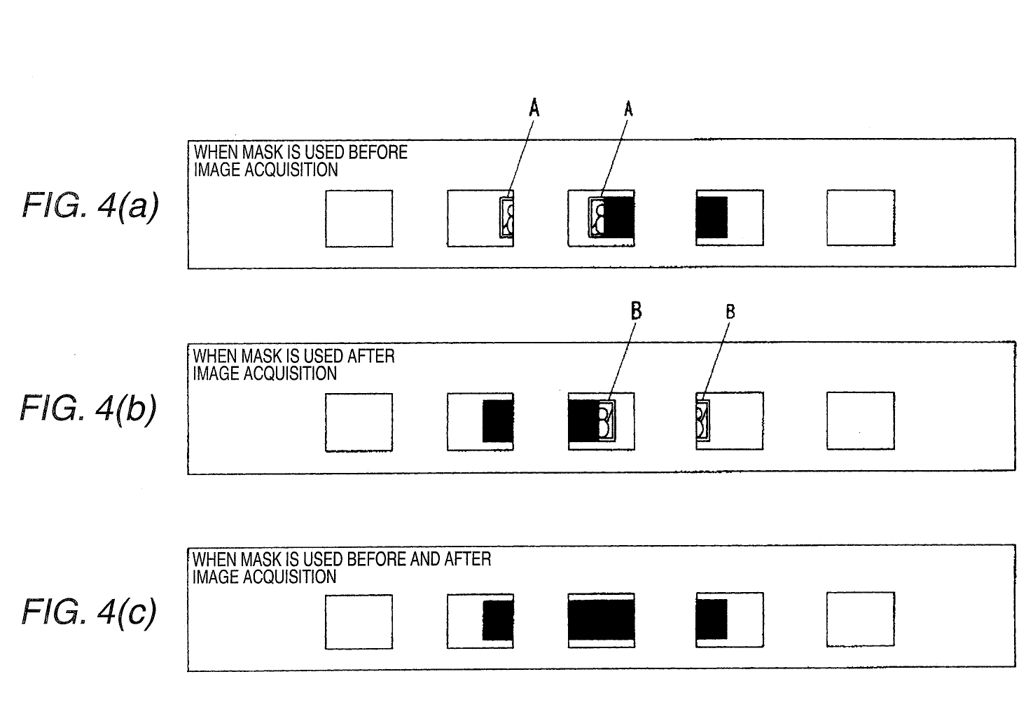

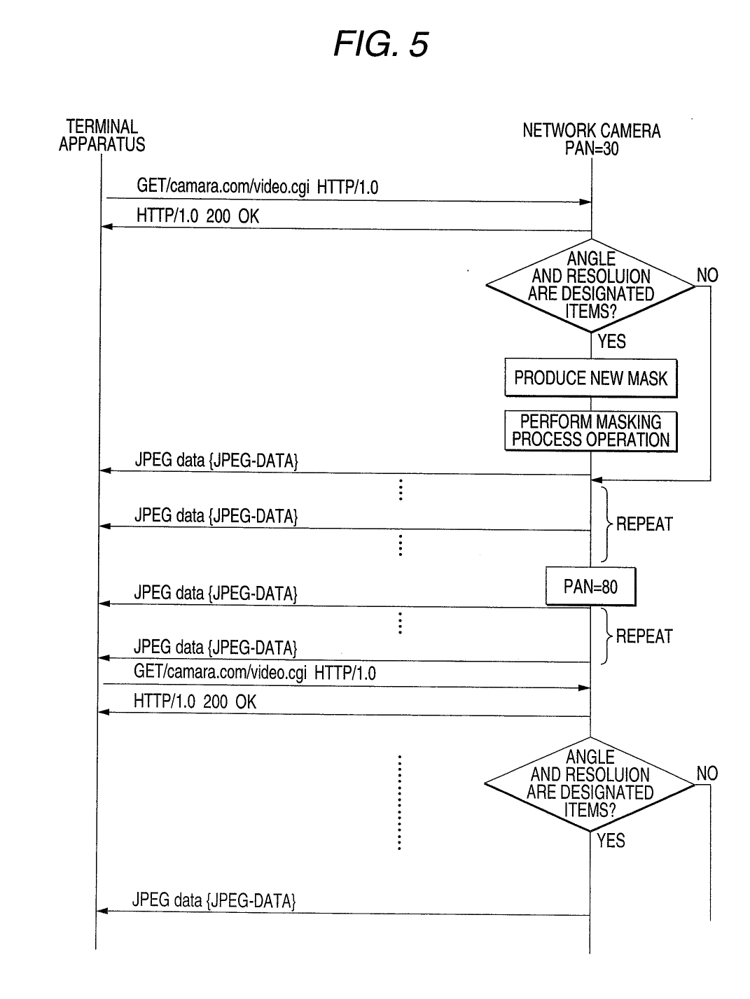

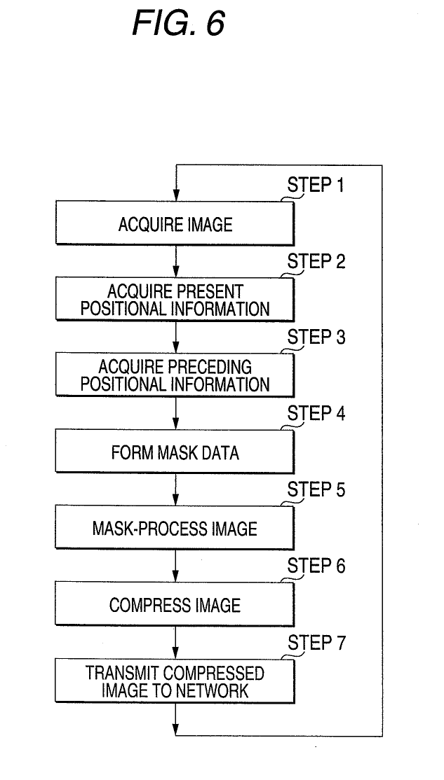

A description is made of network camera according to a first embodiment which includes the present invention. FIG. 1 is a diagram for showing a network structure of a network camera system according to the first embodiment. FIG. 2 is a diagram for indicating an arrangement of a network camera according to the first embodiment. FIG. 3 is an explanatory diagram for explaining a masking process operation of the network camera according to the first embodiment. FIG. 4(a) is an explanatory diagram in the case that a privacy zone is exposed in a masking operation before an image is acquired; FIG. 4(b) is an explanatory diagram in the case that a privacy zone is exposed in a masking operation after an image is acquired; and FIG. 4(c) is an explanatory diagram in the case that a privacy zone is not exposed in a masking operation before and after an image is acquired. FIG. 5 is a sequential diagram for representing an image communicating operation performed in the network camera system according to the first embodiment. FIG. 6 is a flow chart for describing a masking process operation of the network camera according to the first embodiment.

In FIG. 1, reference numeral 1 indicates an IP network such as the Internet and an intranet, which performs a communication operation by employing TCP/UDP, or IP. Reference numeral 2 indicates a network camera by which an image photographed by an image acquiring unit 12 (discussed below) is recorded and is transmitted; and reference numeral 3 represents a terminal apparatus capable of accessing via the IP network 1 to the network camera 2.

Also, reference numeral 4 shows an imaging lens; reference numeral 5 indicates a panning angle changing unit on which the imaging lens 4 is provided, and which changes a panning angle; and reference numeral 6 denotes a tilting angle changing unit for changing a tilting angle.

The imaging lens 4 corresponds to a movable lens which is movable to focused points in order to perform an AF (Automatic Focusing) control operation. Alternatively, this photographing lens 4 may be made of a lens having a fixed focal point. In this case, a process operation of an optical system as an AF control operation is not carried out, but a digital zooming process operation is carried out, namely, enlarging/compressing process operation is carried out by performing a calculation with respect to acquired image data.

An internal arrangement of the network camera 2 is shown in FIG. 2. In FIG. 2, reference numeral 11 shows a network unit which performs a communication control operation between the IP network 1 and the network camera 2 based upon a protocol such as HTTP. Alternatively, the IP network 1 may be communicated with the network unit 11 by using, for instance, FTP, or SMTP instead of HTTP. Reference numeral 11a indicates a camera server provided in the network unit 11. The camera server 11a can transmit image data in the Motion-JPEG format, the JPEG format or the like by employing a transfer protocol such as HTTP etc. In the first embodiment, the camera server 11a is a Web server for performing a communication by employing HTTP, while the Web server 11a receives a request issued from a Web browser at the terminal apparatus 3 so as to transmit either image data photographed by the network camera 2 or image data which has been recorded in the network camera 2.

Next, reference numeral 12 indicates an image acquisition unit which mounts the imaging lens 4 and photoelectrically converts light received by this imaging lens 4. Reference number 13 shows an imaging unit which is constituted by a light receiving cell such as a CCD which receives light passed through the imaging lens 4. Reference numeral 14 represents an image signal processing unit. The image signal processing unit 14 processes R, G, B signals, or complementary color signals, which correspond to output signals from the imaging unit 13, so as to produce a luminance signal Y, a color difference signal Cr, and another color difference signal Cb. The image signal processing unit 14 can also perform a contour correcting process operation, a γ (gamma) correcting process operation, and the like. Although not shown, an electronic shutter with respect to the imaging unit 13, and an imaging control unit for performing a zooming process operation and an exposure time control operation can be provided in image acquiring unit 12.

It should be understood that since the first embodiment includes a the network camera 2 having an optical zooming function, the optical system can be controlled so as to acquire images at a high resolution and at a low resolution. However, in such a case that digital zooming is performed, although not shown in the drawing, a plurality of output means for switching between a plurality of possible resolutions may be provided in the image signal processing unit 14. With employment of these resolution output means, a signal outputted from the light receiving cell of the imaging unit 13 may be outputted in low resolution of 320×240 pixels, or this signal may be changed to be outputted in high resolution of 640×480 pixels.

Reference numeral 15 indicates an image compressing unit. The image compressing unit 15 captures an output signal from the image signal processing unit 14 at predetermined timing, and compresses this captured signal in the JPEG format, especially in the Motion JPEG format, and the like. The image compressing unit 15 divides, for example, an image of one field into a plurality of image blocks where each block is made of 8×8 pixels (namely, 64 pixels), and quantizes each of blocks which have been discrete cosine transform (will be referred to as “DCT” hereinafter)—processed, and then encodes the quantized DCT block so as to output the encoded DCT block.

When the description is furthermore continued, in FIG. 2, reference numeral 16 indicates a drive control unit which drives/controls a panning motor (not shown), a tilting motor (not shown), and a zooming motor (not shown). Reference numeral 17 shows a position detecting unit such as an encoder which generates for example a pulse every time each of the above-described motors is rotated by one turn under control of the drive control unit 16.

The position detecting unit 17 is provided with information describing the motion of the panning motor, the tilting motor, and the zooming motor, respectively. As a consequence, in the case where panning movement and tilting movement are carried out, since the panning motor, or the tilting motor is rotated by 1 turn, the position detecting unit 17 generates 1 pulse, and thus, an optical axis “C” of the network camera 2 is rotated by an angle of “Δθ” along a right direction, a left direction, an upper direction, or a lower direction in response to the generated 1 pulse. Accordingly, when the position detecting unit 17 detects “n” pieces of pulses, the optical axis “C” is rotated by an angle of “n×Δθ.” Similarly, in the case of the zooming operation, when the position detecting unit 17 counts “n” pieces of pulses, the focal distance of the imaging lens 4 is moved. As a result, the focal position of the imaging lens 4 is adjusted. It should also be noted that when the above-described digital zooming process operation is carried out, although these motors is not provided, a total pixel number is adjusted by the image acquiring unit 12 in accordance with zooming magnifying power which is separately entered so as to perform enlarging/compressing process operations.

Reference numeral 18 shown in FIG. 2 indicates a storage unit built in the network camera 2 which stores thereinto a control program and various sorts of data. Reference numeral 18a shows a setting unit which stores thereinto information of a mask area in order to protect a privacy zone set from the terminal apparatus 3. The mask area information implies positional information of a predetermined imaging object whose display is not permitted. The privacy zone implies the predetermined imaging object whose display is not permitted. The mask area is made of a rectangular zone, and is set by recording a center position (namely, position of optical axis “C”) of the screen, and by designating positions of four corners by an operator who uses a GUI (Graphic User Interface) on the display of the terminal apparatus 3. It should also be noted that since the mask zone is formed in the rectangular shape, if the positional information of three corners is available, then the rectangular mask zone can be specified. Then, the mask area need not be made of the rectangular shape, and in this case, positions for specifying this zone are set.

Next, reference numeral 18b represents a preceding information memory unit which stores thereinto positional information of a mask area and masking data when an image acquired in one preceding field (namely, acquired image in preceding field) is mask-processed. The positional information and the masking data stored in the preceding information memory unit 18b are updated every time an image is acquired. Also, reference numeral 18c shows a storage unit for storing thereinto this data having the JPEG format in accordance with a setting condition, while the data having the JPEG function has been produced in the image compressing unit 15. Reference numeral 18d indicates a buffer unit which temporarily stores thereinto the image data produced in the image compressing unit 15 in order to process this stored image data.

Referring now to FIG. 3, a description is made of the positions of the mask area, which are stored in the setting unit 18a and the preceding information memory unit 18b, and furthermore, positions of a mask area which are obtained in calculations. FIG. 3 conceptually represents a relationship among images, a privacy zone, and a mask area when the network camera 2 is panned along right and left directions. When the network camera 2 is tilted, since directions of the network camera 2 are merely changed from the right/left directions into upper/lower directions, a conceptual relationship among images, the privacy zones, and the mask area is similar to that of the panning movement. Assuming now that the optical axis “C” (namely, center of image) of the network camera 2 is located at a position of an angle “θ” from a reference position, and is rotated by an angle “Δθ” by 1 pulse, and then, has reached the present position at this angle “θ” when the counter of the position detecting unit 17 counts “nth” pulse, a physical angle is given as follows: θ=n×Δθ. Also, assuming that a pulse number which constitutes 1 pitch between the respective fields is defined as “p” pulses, positional information of a center within an “ith” field is given as follows: n=p×i pulses.

A masking process operation with respect to the acquired image will now be simply described. It is so assumed that positional information on the screen of the network camera 2 is expressed by (n, x, y) as coordinates. In this assumption, symbol “n” indicates a pulse number which is counted until the optical axis “C” of the network camera 2 is directed to a predetermined direction; symbol “x” represents a position of the panning direction in the unit of a pixel, while a center (optical axis “C”) within the screen at this time is set as a reference (0, 0); and symbol “y” shows a position of the tilting direction in the pixel unit while the center within the screen is similarly set as the reference. It should also be noted that this expression of the coordinate system is merely employed so as to briefly explain the coordinate system. Therefore, the present invention is not limited to this coordinate expression.

Masking data for performing the masking process operation is formed in accordance with the below-mentioned manner: That is, while a value of “x” at a left end (left edge) within this area is defined an initial value, this initial value is incremented up to a right end (right edge) (namely, from “k” up to “l” in below-mentioned explanation) in such a way of x=x+1 so as to acquire respective coordinates, and also, while a value of “y” at a lower end (lower edge) is defined as an initial value, this initial value is incremented up to an upper end (upper edge) (namely, from “−m” up to “m” in below-mentioned explanation) in such a way of y=y+1 so as to acquire respective coordinates. Thereafter, a predetermined data which have been set with respect to the respective points for the masking process operation are applied to all of the points within the area so as to form the masking data. For example, if the predetermined data are binary data, then either “1” or “0” is applied to all of these points within the area.

In this case, symbol “LU” shown in FIG. 3 indicates an upper left end of the mask area; symbol “LD” shows a lower left end thereof; symbol “RU” represents an upper right end thereof; and symbol “RD”; shows a lower right end thereof. Among images shown in FIG. 3, images to be masked are displayed over two screens; both the upper left end LU and the lower left end LD of the mask area appear in a field exposed during an “ith (“p·i”th pulse) image acquisition time period; and both the upper right end RU and the lower right end RD appear in a field exposed during an (i+1)th (“p·(i+1)”th pulse) image acquisition time period. The upper left end LU, the lower left end LD, the upper right end LU, and the lower right end RD are expressed based upon relative coordinates of a screen of 1 field, for example, in such a screen constructed of 320×240 pixels, these ends (edges) expressed based upon the relative coordinates while the optical axis “C” is defined as a center (0, 0). Each of points within the screen is expressed by using a relative coordinate having a value in a range from −160 to 160 in the pixel unit along the panning direction, and a relative coordinate having a value in a range from −120 to 120 in the pixel unit along the tilting direction.

The mask area in the case shown in FIG. 3 is given as follows: That is, the upper left end LU is present in the “ith” field (namely, such a field that center position is θ=p·i·Δθ), and the relative coordinates thereof are, for example, (k, m) and the relative coordinates of the lower left end LD are (k, −m). In this “ith” field, the mask field is defined by (j, m) to (j, −m) with respect to “j” which is expressed by such an integer of k<j≦160, and an area has been masked which is surrounded by 4 points of (k, m), (k, −m), (160, m), and (160, −m).

Similarly, the upper right end RU and the lower right end RD are present in the (i+1)th field (namely, such a field that center position is θ=p·(i+1)), and while the optical axis “C(0,0)” is set as a center, the relative coordinates of the upper right end RU are expressed as, for example, (l, m); and the relative coordinates of the lower right end RD are expressed as (l, −m). In this (i+1)th field, the mask field is defined by (j, m) to (j, −m) with respect to “j” which is expressed by such an integer of 160≦j<1, and an area has been masked which is surrounded by 4 points of (i, m), (l, −m), (−160, m), and (−160, −m).

As a consequence, positional information as to the area masked in FIG. 3 is given as the upper left end LU (k, m) and the lower left end RD (k, −m) in the “ith” field; the upper right end RU (l, m) and the lower right end RD (l, −m) in the (i+1)th field. When the positional information is expressed in the above-described format (n, x, y) in combination with the positional information of the optical axis “C”, this positional information becomes LU (p·i, k, m), LD (p·i, k, −m), RU (p·(i+1), l, m), RD (p·(i+1), l, −m).

As previously described, it should also be noted that an operation for setting this mask area is carried out in a mask setting mode based upon an image transmitted from the network camera 2, and this mask area is set by designating the positions of the four corners displayed on the screen of the terminal apparatus 3 by the inputting operation using the GUI. Firstly, a center of such an area whose display is not permitted is selected by a cursor, and thereafter, a rectangular designation zone is expanded/compressed so as to set the mask area. The contents of this setting operation are transmitted to the network camera 2, and then, the positional information such as the above-described LU, LD, RU, RD as the relative coordinates which give the rectangular zone is stored in the setting unit 18a in combination of the positional information (p·i pulses).

Furthermore, returning back to FIG. 2, the description of the arrangement of the network camera 2 is continued as follows: That is, reference numeral 19 indicates a control unit capable of achieving respective functions by reading a program in a CPU (Central Processing Unit) functioning as hardware. Then, reference numeral 20 represents a mask control unit. When a request message of an image issued from the terminal apparatus 3 is delivered to a camera server 11a provided in the network unit 11, the mask control unit 20 judges whether or not a portion of a mask area is present in the image acquired by the image acquiring unit 12 so as to mask the acquired image. Also, reference numeral 20a indicates a mask position calculating unit which calculates positional information of the mask area based upon the positional information of the optical axis “C” detected by the position detecting unit 17. Reference numeral 20b shows an enlarging/compressing unit which calculates enlargement/compression of the mask area when a zooming operation is carried out.

A description is made of such an event that a masked position is shifted from a position of an image, so that an exposure of a privacy zone occurs with reference to FIG. 4(a), FIG. 4(b), and FIG. 4(c). For example, while the network camera 2 is panned, if the counter of the position detecting unit 17 counts “n” pulses, then the mask position calculating unit 20a judges that positional information of an image center of this field corresponds to the position (corresponds to θ=n×Δθ as physical angle).

In this case, assuming now that a total number of pulses for one pitch between the respective fields is equal to “p” pulses, a center of the “ith” field becomes a position of n=p×i pulses, and a center of the (i+1)th field becomes a position of n=p×(i+1) pulses. Then, when the network camera 2 is furthermore rotated, it is so assumed that symbol “q” is a total number of pulses which are counted in order to intersect a screen made of 320×240 pixels along the panning and tilting directions, and symbol “ω” is a total number of pixels when the network camera 1 is rotated (moved) on the screen in response to one pulse. In the case that the network camera 2 is intersected along the panning direction, q ω≦320, and moving speeds of the network camera 2 along the panning/tilting directions are direct proportional to “ω.”

Next, when an area is designated as the mask area by four points of LU (p·i, k, m), LD (p·i, k, −m), RU (p·(i+1), l, m), RD (p·(i+1), I, −m) shown in FIG. 3, the mask control unit 20 does not perform the masking process operation with respect to images which have been acquired from the first field up to the (i−1)th field, but the images are transmitted without masking operations. To the contrary, as to an image acquired in the “ith” field, the mask control unit 20 masks such an area (−160—k≦159) which is surrounded by four points of (k, m), (k, −m), (160, m), and (160, −m). Also, as to an image acquired in the (i+1)th field, the mask control unit 20 masks such an area (−159≦k≦160) which is surrounded by 4 points of (i, m), (l, −m), (−160, m), and (−160, −m).

On the other hand, a length of time is necessarily required so as to calculate a position of a mask area with respect to an image, to produce masking data, to perform a masking process operation of the image, and also to perform process operations in combination with other operations, so that these calculating operations cannot catch up with the panning and tilting movement, resulting in a delay time. Assuming now that if this delay time is counted based upon pulse number, then it becomes “λ” pulses. Using the example of the case shown in FIG. 3, due to this delay in forming a mask with respect to an acquitted image, the four points of the mask area with respect to the “ith” image effectively cause forming of a mask with respect to an image preceding the current image by the “λ” pulses. As a result, positional information of the mask is given as: LU ((p·i−λ), k, m), LD ((p·i−λ), k, −m), RU ((p·i−λ), 160, m), RD ((p·i−λ), 160, −m). With respect to the image of the next (i+1)th field, positional information of the mask is given as: LU ((p·(i+1)−λ), −160, m), LD ((p·(i+1)−λ), −160, −m), RU ((p·(i+1)−λ), l, m), RD ((p·(i+1)−λ), l, −m).

As a consequence, areas of images which are actually masked by the above-described mask are given as follows: that is, with respect to the image of the “ith” field, the area of this image is given as: LU (p·i, (k−λ·ω), m), LD (p·i, (k−λ·ω), −m), RU (p·i, 160, m), RD (p·i, 160, −m). Similarly, with respect to the image of the (i+1)th field, the area of this image is given as: LU (p·(i+1), −160, m), LD (p·(i+1), −160, −m), RU (p·(i+1), (1−λ·ω), m), RD (p·(i+1), (1−λ·ω), −m).

As explained above, in such a case that with respect to the image of the “ith” field (namely, “(p·i)th” pulse), the mask formed after this image has been acquired is used, an actual mask area with respect to the image is delayed by “λ·ω” pixels along the panning direction from the original area. If the above-described image is masked by using this formed mask, then such an area surrounded by 4 points of ((1−λ·ω), m), (1−λ·ω), −m), (l, m), (l, −m) is exposed which corresponds to a tail portion of a privacy zone which should be originally masked, although the original mask area should be another area surrounded by 4 points of the relative coordinates of (k, m), (k, −m), (l, m), and (l, −m).

In contrast thereto, in such a case that with respect to the image of the “ith” field, such a mask formed by acquiring the image of the “(i−1)th” field is used, namely, the mask formed when the image of the preceding field was acquired is used, such an area surrounded by 4 points of ((k−λ·ω), m), ((k−λ·ω), −m), (k, m), (k, −m) is exposed. This surrounded area corresponds to a head portion of the privacy zone. This mask before the image acquisition is explained in the below-mentioned description.

Next, FIG. 4(a) and FIG. 4(b) represent the above-described conditions, namely show a condition of a comparison example 1 when the image is masked by employing the mask before the image acquisition, and another condition of a comparison example 2 when the image is masked by employing the mask after the image acquisition. In FIG. 4(a), when the network camera 2 is panned up to the privacy zone, “A” of the above-described head portion is shifted due to the mask before the image acquisition, so that an image is exposed. To the contrary, in FIG. 4(b), when the network camera 2 is panned up to the privacy zone, “B” of the above-described tail portion is shifted due to the mask after the image acquisition, so that an image is exposed.

As a consequence, in the first embodiment, a masking process operation is carried out by utilizing two sets of the masks before and after the images are acquired in combination with each other. In other words, in a masking process operation executed while the network camera 2 is panned and tilted, an occurrence of a shift of a mask area cannot be avoided. Also, if a huge amount of calculating operations are carried out in order to correct the shift of the mask area, then the calculating operations may probably cause a further delay, and moreover, such calculating operations may be contradictory to the original object of the present invention and may conduct high cost. Accordingly, in the first embodiment, the masking process operations are simply and firmly carried out by employing two sets of the masks formed before and after the image acquisitions. At this time, the images are mask-processed by employing such a mask having masking data (namely, two masks are overlapped with each other to become single masking data), so that the exposed portions due to the shifts of the above-described “A” and “B” can completely disappear.

The above-explained masking process operations will now be described in detail. It is so assumed that when a masking process operation as to the image of the (i−1)th field is carried out immediately after this image has been acquired, forming of a mask is delayed by “λ pulses.” When such a case is considered that forming of this mask is further delayed, for instance, a mask is formed at a head portion of the “ith” field, this timing is assumed as a time instant when formed of the mask is delayed by “λ′ pulses.” A mask area of such a mask which is formed with the delay by “λ′ pulses” is delayed by the “λ′ pulses”, so that this mask area is defined by 4 points of LU ((p·(i−1)−λ′), k, m), LD ((p·(i−1)−λ′), k, −m), RU ((p·i−λ′), l, m), RD ((p·i−λ′), l, -m). If “λ′” is made equal to “λ′” (namely, λ′=λ), then it becomes the mask area in such a case that the mask is formed immediately after the image of the (i−1)th field has been acquired.

An area which is actually masked in the acquired images of the “ith” field and the (i+1)th field is given as: LU (p·i, (k−λ·ω), m), LD (p·i, (k−λ·ω), −m), RU (p·(i+1), (l−λ·ω), m), RD (p·(i+1), (l−λ·ω), −m). Then, this actually masked area is employed as a mask of the (i−1)th field which has been formed by the λ′ pulse delay. If this mask is employed as the mask with respect to the images acquired in the “i”th field and the (i+1)th field, then a delay is further added due to the shifts of λ′ and λ, so that the mask are is given by the following relative coordinates: LU ((k−(λ′−λ)·ω), m), LD ((k−(λ′−λ)·ω), −m), RU ((1−(λ′−2λ)·ω), m), RD ((1(λ′−2λ)·ω), −m).

A description is made of such a case that a mask is formed immediately after the image of the (i−1)th field based upon this idea, namely in the case of λ′=−λ. A left end of a mask area with respect to the image acquired in the “i”th field becomes LU (k, m), LD (k, −m) in the relative coordinates. Since an image acquired when the network camera 2 is panned in a high speed precedes a mask, as previously described, the portion is exposed which is surrounded by the 4 points of ((k−λ·ω), m), ((k−λ·ω), −m), (k, m), (k, −m). However, a right end of the mask area becomes RU ((1+λ·ω), m), RD ((1+λ·ω), −m), in the image acquired in the (i+1)th field, so that such an image of a wide range which covers the positions up to the delayed position can be masked.

Since the λ′ pulse can be arbitrarily set irrespective of the λ pulse, as previously explained, if the image is masking-processed by the mask of the (i−1)th field at the head portion of the image acquisition period of the “ith” field, then the image can be more firmly masked in a safe manner. In this case, λ′=(p−q); a value which is slightly larger than “q” is given to “p” in order to satisfy 2λ<(p−q). As previously described, symbol “p” indicates a total number of pulses for 1 pitch between the respective fields, and symbol “q” shows a total number of pulses which are required to intersect a single screen.

As a consequence, in the first embodiment, while two pieces of the positional information as to the two masks formed before and after the image acquisitions are used with each other, the novel masking data is produced based upon the single mask area obtained from these two masks, and then, the acquired image is masked by using this masking data. In other words, based upon both the positional information of the present field (namely, positional information of mask area of “ith” field), and the positional information of the preceding field (namely, positional information of mask area of “(i−1)th” field), such a mask area can be realized which is surrounded by the 4 points of: LU ((k−λ·ω), m), LD ((k−λ·ω), −m), RU ((l+λ·ω), m), RD ((l+λ·ω), −m). As represented in FIG. 4(c), the exposed portions of the privacy zones caused by the shifts of A and B can be completely deleted.

It should also be understood that although the above-explained first embodiment has described the masking process operations performed while the network camera 2 is mainly panned, the system described in the first embodiment may be realized in a similar manner by performing masking process operations while the network camera 2 is tilted, so that the masking process operation may be carried out by using two masks formed before and after image acquisitions. Since a detailed masking process operation of the tilting movement is overlapped with that of the panning movement, a description thereof is omitted.

Also, in the case where a zooming operation is performed, and furthermore, in the case that a zooming operation is carried out while panning and tilting operations are carried out, when the zooming magnifying power of the network camera 2 is changed so as to acquire enlarged/compressed images, a mask area of a preceding field is enlarged/compressed in accordance with the zooming magnifying power of the network camera 2. While such a mask of an image is used which contains the enlarged/compressed mask area of the preceding sequence and the mask area of the present sequence, a masking process operation is carried out with respect to an image acquired by the image acquiring unit 12. As a result, although the calculations required for the enlarging/compressing process operations with respect to the mask area are increased, the enlarged/compressed images can be firmly mask-processed by utilizing the masks formed before/after the image acquisitions.

That is to say, in the first embodiment, the enlarging/compressing unit 20b shown in FIG. 2 calculates the preceding mask area based upon the data stored in the preceding information memory unit 18b and the positional information of the position detecting unit 17, namely calculates the positional information (namely, LU, LD, RU, RD) of the area which forms such a mask having the maximum wideness, while the above-described mask area contains the preceding mask area in which the positional information of LU, LD, RU and RD has been changed in accordance with the zooming magnifying power, and the present mask area. The enlarging/compressing unit 20b masks the presently acquired image during the zooming operation (image acquired while resolution of network camera is changed) by employing a new mask. Then, after the masking operation is accomplished, the information as to the mask area stored in the preceding information memory unit 18b is updated by using the information (namely, LU, LD, RU, RD, and masking data) as to the presently formed mask area.

Next, a description is made of operations performed in such a case that the terminal apparatus 3 transmits an image request to the network camera 2, and an image transmitted from the network camera 2 is displayed on the terminal apparatus 3 in a continuous manner with reference to FIG. 5. It is so assumed that in this network camera 2, the optical axis “C” has been directed to, for example, a direction of a panning angle of 30 degrees in a beginning stage.

Firstly, in order to require an image from the terminal apparatus 3 to the network camera 2, as represented in FIG. 5, when the terminal apparatus 3 transmits a first request message such an “GET/camera. com/video. cgi HTTP/1.0” to the URL of the network camera 2, and an image having resolution of 320×240 pixels and a panning angle of 80 degrees is requested by way of CGI, the network camera 2 returns a packet of “HTTP/1.0 200 OK” in order to transmit JPEG data {JPEG-DATA}, so that a communication link is established between the terminal apparatus 3 and the network camera 2 by the above-described operations.

Thereafter, the network camera 2 under connection judges whether or not the present panning angle is equal to the designated panning angle of 80 degrees. If the present panning angle is not equal to 80 degrees, then the network camera 2 performs an image acquisition while the network camera 2 is rotated in order that the present panning angle becomes 80 degrees. The network camera 2 calculates a new mask area from a present mask area and a preceding mask area, and forms masking data with respect to an acquired image so as to mask the acquired image, and then, transmits this JPEG data {JPEG-DATA} to the terminal apparatus 3.

In such a case that the terminal apparatus 3 continuously requires images, the network camera 2 again judges whether or not a present panning angle becomes equal to 80 degrees after the above-described sequence, and executes the process operations up to the masking process operation so as to transmit the JPEG data {JPEG-DATA}. While the network camera 2 repeatedly performs this operation, if the present panning angle becomes 80 degrees, then the terminal apparatus 3 executes only the masking process operation so as to continuously transmit the JPEG data {JPEG-DATA}. This operation is continued until the terminal apparatus 3 transmits such a notification that the image request is stopped. During this operation, when the terminal apparatus 3 changes the panning angle of 80 degrees to another panning angle of 100 degrees, and also, changes the present resolution to another resolution of 640×480 pixels, the terminal apparatus 3 transmits “HTTP/1.0 200 OK” with respect to a request message for requesting a panning angle and resolution, and repeatedly performs the above-described operations.

Referring now to a flow chart of FIG. 6, a description is made of a sequence as to the above-described masking process operations executed by the network camera 2 according to the embodiments. Firstly, the imaging unit 13 of the network camera 2 acquires an image (step 1), and stores the acquired image into the buffer unit 18d.

Next, positional information of such an optical axis “C” where the image has been acquired in the present time is acquired from the position detecting unit 17 such as the encoder (step 2). It should be understood that a total number of pulses counted by a counter, or the like constitutes the positional information. Furthermore, the positional information (mask area) of such an optical axis “C” where the image of the preceding time (1 preceding field) had been acquired is read out from the preceding information memory unit 18b (step 3). A new mask area is calculated based upon both the positional information (mask area) of the present time (present field) and the positional information (mask area) of the preceding time (1 preceding field), and then, the calculated mask area is incremented along the panning direction and the tilting direction so as to form masking data which is used in a masking process operation (step 4).

An acquired image is mask-processed by using the masking data formed in the step 4 (step 5). The mask-processed image data is processed by performing, for example, a DCT transforming process operation, a quantizing process operation, and an encoding process operation, so that the finally-processed image data is compressed in the JPEG format (step 6). The resulting image data of the JPEG format is transmitted to the network 1 (step 7). Thereafter, this image data of the JPEG format is recorded in the storage unit 18c in accordance with the setting condition, and then, the process operation is returned to the previous step 1. When an image is continuously acquired as represented in FIG. 5, a series of the above-described process operations is repeatedly carried out.

As previously described, when the network camera 2 of the embodiment 1 acquires such images containing a privacy zone while the network camera 2 is panned and tilted, the network camera 2 forms masking data by using a mask area of an image acquired in the present timing and another mask area of another image acquired in the preceding timing, and then, performs a masking process operation with respect to the acquired image. As a result, the network camera 2 of the embodiment 1 can firmly avoid that such an image which is not wanted to be displayed is exposed.

Also, similarly, when the network camera 2 of the embodiment 1 performs a zooming operation, the network camera 2 enlarges and/or compresses the mask area of the image acquired in the preceding timing in order to become the resolution of the mask area of the image acquired in the present timing in accordance with the zooming magnifying power, and then, forms a single mask from this enlarged/compressed mask area of the preceding timing, and the mask area of the present timing so as to calculate LU, LD, RU, and RD. As a result, the network camera 2 can perform the masking process operation in the simple and firm manners.

A description is now made of a network camera 2 according to a second embodiment. The network camera 2 of this second embodiment is operated in a manner which is different from the operation of the first embodiment in that, according to the second embodiment, a single mask is formed based upon the two masks so as to form the masking data and the masking process operation is carried out based upon the formed masking data. That is, in the network camera 2 of the second embodiment, first masking data is formed based upon positional information of present timing and then a first masking process operation is carried out with respect to an image acquired in the present timing based upon the formed first masking data, and furthermore, a second masking process operation is carried out based upon second masking data employed in a masking process operation of preceding timing with respect to the image formed after the first processing operation.

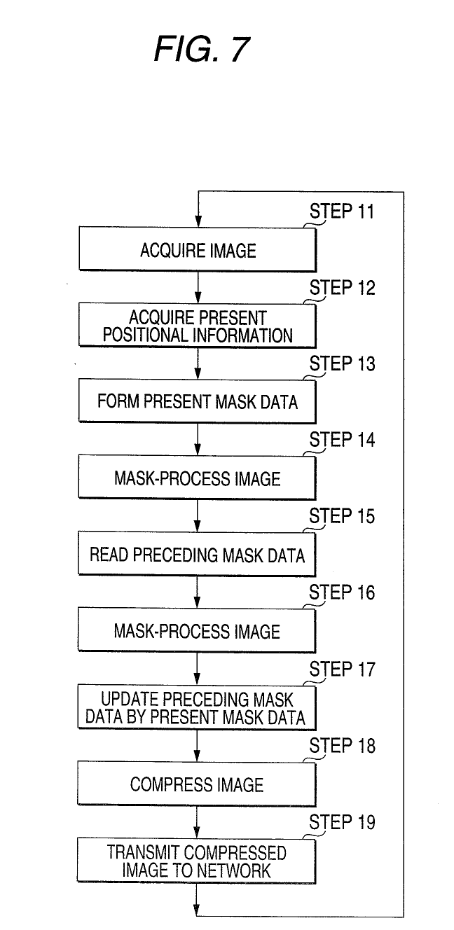

As a consequence, an arrangement of the network camera 2 according to the second embodiment is similar to the arrangement of the network camera 2 according to the first embodiment, although sequences of process operations of the second embodiment are different from those of the first embodiment. Since the same reference numerals indicate the same structural elements, descriptions thereof are omitted in this second embodiment. Accordingly, process operations of the second embodiment will now be described also with reference to FIG. 1 to FIG. 6. FIG. 7 is a flow chart for describing masking process operations of the network camera 2 according to the second embodiment. In the flow chart of FIG. 7, the imaging unit 13 of the network camera 2 acquires an image (step 11), and stores the acquired image into the buffer unit 18d.

Next, positional information of such an optical axis “C” where the image has been acquired in the present time is acquired from the position detecting unit 17 such as the encoder (step 12). Then, masking data of the present time (namely, first masking data) is formed based upon this positional information (step 13). It should be noted that masking data is obtained in such a manner that edge positions (LU, LD, RU, RD) of a mask area are calculated with respect to a screen obtained from positional information, and the mask area is incremented from the left end positions LU, LD, and the right end positions RU, RD so as to apply predetermined data to respective points within an area. An image acquired in the present image acquisition is mask-processed (namely, first mask processing operation) based upon this masking data (step 14).

Subsequently, the masking data (second masking data) by which the masking process operation of the preceding time (1 preceding field) has been carried out is read out from the preceding information memory unit 18b (step 15). Next, the image which has been mask-processed (first masking process operation) in the step 14 is mask-processed (namely, second masking process operation) based upon the read masking data (namely, second masking data) (step 16).

Moreover, the masking data (second masking data) of the preceding time (1 preceding field) stored in the preceding information memory unit 18b is updated by the masking data (first masking data) obtained in the step 13 (step 17). This data is processed by performing, for example, a DCT transforming process operation, a quantizing process operation, and an encoding process operation, so that the image of the finally-processed masking data is compressed in the JPEG format (step 18). The resulting image data of the JPEG format is transmitted to the network 1 (step 19). Thereafter, this image data of the JPEG format is recorded in the storage unit 18c in accordance with the setting condition, and then, the process operation is returned to the previous step 11. When an image is continuously acquired as represented in FIG. 5, a series of the above-described process operations is repeatedly carried out.

As previously described, when the network camera 2 of the second embodiment acquires such images containing a predetermined imaging object of a privacy zone while the network camera 2 is panned and tilted, the network camera 2 performs masking process operations two times in an overlap manner by using masking data with respect to an image acquired in the present imaging timing and another masking data with respect to another image acquired in the preceding imaging timing. As a result, the network camera 2 of the second embodiment can firmly avoid that such an image which is not wanted to be displayed is exposed.

Also, similarly, when the network camera 2 of the second embodiment performs a zooming operation, the network camera 2 forms a mask from the mask area of the present imaging timing, and calculates LU, LD, RU, and RD so as to perform a first masking process operation. Subsequently, the network camera 2 enlarges and/or compresses the mask area of the preceding imaging timing in order to become the resolution of the mask area of the present imaging timing in accordance with the zooming magnifying power, and then, performs a second masking process operation based upon this enlarged/compressed mask area of the preceding imaging timing. As a result, the network camera 2 can perform the masking process operations in the simple and firm manners.

This application is based upon and claims the benefit of priority of Japanese Patent Application NO. 2006-216890 filed on Aug. 9, 2006, the contents of which are incorporated herein by references in its entirety.

What is claimed is:

1. A network camera comprising:
a camera configured to photograph an image, the camera being movable within a predetermined range;
a memory configured to store positional information for a predetermined zone, which predetermined zone is to be excluded from a display of the image; and
a controller configured to control the camera to move within the range and to acquire a series of images from the camera at regular intervals,
and to perform a masking operation, upon a determination that the predetermined zone is within a present image, to mask an image area, the image area including both the image of the predetermined zone acquired at a present time and the image of the predetermined zone acquired at one interval prior to the present time.

2. The network camera according to claim 1, wherein the controller is configured to define, as a starting edge of a mask, a starting edge of the image of the predetermined zone acquired at one interval prior to the present time and to define, as an ending edge of the mask, an ending edge of the image of the predetermined zone acquired at the present time, and the controller is configured to perform the masking operation with respect to the image area, the image area being surrounded from the starting edge of the mask to the ending edge of the mask.

3. The network camera according to claim 1, wherein the controller is configured to, after acquiring an image including the predetermined zone, enlarge the acquired image, and to mask the image area, the image area including both the image of the predetermined zone acquired and enlarged at the present time and the image of the predetermined zone acquired and enlarged at one interval prior to the present time.

4. The network camera according to claim 1, wherein, the controller is configured to, after acquiring an image including the predetermined zone, to reduce the acquired image, and to mask the image area, the image area including both the image of the predetermined zone acquired and reduced at the present time and the image of the predetermined zone acquired and reduced at one interval prior to the present time period.

5. The network camera according to claim 1 further comprising an interface configured to provide a connection to a terminal apparatus.

6. The network camera according to claim 1, wherein the controller is configured to overlap both the image of the predetermined zone acquired at a present time and the image of the predetermined zone acquired at one interval prior to the present time and to perform the masking operation with respect to the overlapped images.

7. The network camera according to claim 1, wherein the memory is configured to store first positional information of the image of the predetermined zone acquired at one interval prior to the present time, and the controller is configured to form a single mask by overlapping the first positional information stored in the memory and second positional information of the image of the predetermined zone acquired at the present time and to perform the masking operation using the single mask.

8. The network camera according to claim 1, wherein the controller is configured to form first masking data based on first positional information regarding the image of the predetermined zone acquired at one interval prior to the present time and to store the first masking data in the memory, and
the controller is configured to form second masking data based on second positional information regarding the image of the predetermined zone acquired at the present time, and to perform the masking operation using the second masking data and the first masking data stored in the memory.

9. A method for controlling a network camera, the network camera having a camera and a memory, the camera being operable to photograph an image and being movable within a predetermined range, the memory being operable to store positional information of a predetermined zone, which predetermined zone is to be excluded from a display of an image, the method comprising:
controlling the camera to move within the range;
acquiring a series of images from the camera at regular intervals; and
performing a masking operation, upon a determination that the predetermined zone is within a present image, to mask an image area, the image area including both the image of the predetermined zone acquired at a present time and the image of the predetermined zone acquired at one interval prior to the present time period.
